(19) United States
(12) Patent Application Publication
(10) Pub. No.: US 2012/0166088 A1
(43) Pub. Date: Jun. 28, 2012

(54) METHOD OF LOCATING HYDRAULIC BARRIERS WITHIN A GEOLOGICAL GAS STORAGE LAYER

(76) Inventors: Noalwenn SALLEE, Paris (FR); Patrick Rasolofosaon, Les Ulis (FR)

(21) Appl. No.: 13/330,916

(22) Filed: Dec. 20, 2011

(30) Foreign Application Priority Data
Dec. 23, 2010 (FR) 10/05.060

(51) Int. Cl. G06F 19/00; G01V 1/30; G01V 1/40

(52) U.S. Cl. 702/11; 702/14

(57) ABSTRACT

A method of locating argillaceous zones present in a geological layer from seismic data where a gas has been injected is disclosed. From a discretization of the layer into a set of cells, a first set of cells containing CO₂ is identified by seismic data analysis of a first criterion. A second set of cells containing shale is identified by a seismic data analysis by a second criterion. The number of cells identified containing both shale and CO₂ is then determined from the set of cells which are identified. The method is repeated by modifying at least one of the criteria until the number of cells is below a selected threshold ε_{wi}

### BACKGROUND OF THE INVENTION

1. Field of the Invention

The invention relates to geological storage of a greenhouse gas, such as carbon dioxide (CO₂), and more particularly to the construction of the static geological model of the subsoil layer used for geological storage of the gas, in order to perform numerical flow modelling to predict the evolution of the injected gas.

2. Description of the Prior Art

Scenarios published by the IPCC (Intergovernmental Panel on Climate Change) show that the CO₂ concentration in the atmosphere, in the absence of any corrective measure, will evolve from a current concentration of 360 ppm to more than 1000 ppm by the end of the XXI^{st} century which will have significant consequences on climate change. Capture of the CO₂ emissions from high volume sources (such as, thermal power plants), transportation of the CO₂ and storage thereof in suitable underground formations is one of the solutions available for reducing greenhouse gas emissions. CO₂ geological storage pilot projects already exist. Continuing the deployment of this technology requires high-quality technologies in order to meet the requirements of the regulations that are being set up and to meet public expectations.

Deep saline aquifers have the highest potential for CO₂ geological storage among all the geological formations considered regarding their geographical distribution and their theoretical storage capacity.

The volume of the CO₂ injected in an underground geological formation is easily known by measuring the gas flow rate at the wellhead. However, the evolution of the CO₂ once injected is much more difficult to control. The CO₂ can migrate vertically out of the storage formation to more superficial geological layers or even to the surface or laterally into a host formation in non-initially planned zones. Furthermore, the CO₂ can undergo physico-chemical changes over time, which are likely to cause it to take different forms, among which are free form (gaseous or supercritical), dissolved form, in brine, or mineralized form.

Thus, monitoring as completely as possible the evolution of the CO₂ has to be performed in order to meet the regulations in force and to help towards societal acceptance of this technology. Complete monitoring must involve (i) repeated measurements over time of pertinent physico-chemical parameters (physical, geophysical and geochemical monitoring) and (ii) numerical modelling of the medium-term and long-term behavior of the CO₂ which is injected into the storage site. The modelling quality depends, among other things, (i) on the possibility of having a precise static geological model of the sub-surface layer and (ii) on the possibility of updating the numerical modelling via the constraint involved by the repeated measurements performed on the storage site.

Among the techniques for monitoring the fluids produced or injected in a porous medium are repetitive geophysical methods and more particularly the repetitive seismic technology which has been developed by industrialists. Thus, the repetitive seismic technology, also referred to as 4D seismic technology, commonly used in the petroleum or environmental industry, carries out various seismic surveys, at different times (the surveys are generally carried out at one year intervals at least) and allows following the evolution of the fluids of the reservoir under production or of the geological storage site.

Conventionally, the seismic data (velocities or impedances) estimated from the acquired data allow finding the elastic properties of the fluids produced or injected by a theoretical model, generally of poroelastic type (Biot-Gassmann). Thus, all these techniques have been used in environmental applications to estimate, from seismic data, the total volume and the total mass of CO₂ in place in the subsoil.

These conventional methods are based on the use of an elastic model of the porous medium for which estimation of key parameters (drained bulk and shear moduli notably, and grain compressibilities to a lesser extent) are still is a problem. They are furthermore based on the necessity of having at least one well and of carrying out well tests in the zone to be evaluated.

Furthermore, these methods do not allow obtaining sufficient accuracy to identify argillaceous zones within the geological storage layer and far away from injection or production wells. These zones have impermeable barriers to CO₂ which conditions the connectivity or lack thereof to some zones of the geological storage layer. Knowledge of connectivity allows determination of the volume of potentially injectable gas into the layer and to ascertain the site integrity. Location of the sub-seismic argillaceous barriers allows better defining of the static model required for any dynamic flow simulation.

### SUMMARY OF THE INVENTION

The present invention is a method, based on the analysis of seismic data, which allows location of sub-seismic argillaceous zones which are potentially present in the geological layer for the purpose of gas storage.

The invention thus is a method of locating argillaceous zones present in a geological layer where a gas has been injected, from seismic data. The method allows disregarding the presence of wells, and therefore of well tests in the zone to be evaluated, and to precisely locate the argillaceous zones and their bases forming hydraulic barriers, and the possible connections between the various compartments of the reservoir, not only at a level of a CO₂ plume, but also in the entire geological layer, far from the injection zone.

In general terms, the invention is a method of locating argillaceous zones present in a geological layer where CO₂ has been injected, from seismic data and from a discretization of the layer into a set of cells. The method comprises the following stages:

a) identifying a first set of cells (PL) containing CO₂ by an analysis using a first criterion of the seismic data;

b) identifying a second set of cells (SH) containing shale by an analysis using a second criterion of the seismic data;

c) determining a number of identified cells containing both CO₂ and shale, from the sets of cells (PL, SH); and

d) repeating a) by modifying at least one of the criteria, until the number of cells is below a selected threshold ε_{wi}.

The following stages can be applied to determine the first set of cells (PL) containing CO₂:

associating with each cell P wave seismic impedance values before and after CO₂ injection and S wave seismic impedance values before and after CO₂ injection, by a stratigraphic inversion of the seismic values;
associating with each cell a bulk modulus variation value from the P wave and S wave seismic impedance values before and after CO₂ injection;
determining the first set of cells (PL) containing CO₂ by identifying cells where the bulk modulus variation is negative with an absolute value above a given first positive threshold εₚₗ.

The following stages can be applied to determine the second set of cells (SH) containing shale:

associating with each cell a P wave seismic impedance value before or after CO₂ injection and an S wave seismic impedance value before or after CO₂ injection by a stratigraphic inversion of the seismic data;
associating with each cell a value of a ratio of the P wave seismic impedance to the S wave seismic impedance; and
determining the second set of cells (SH) containing shale by identifying cells where the ratio is above a given second positive threshold εₛₕ.

According to the invention, at least one of the thresholds can be modified upon each iteration of d) to minimize the number of identified cells containing both CO₂ and shale.

According to an embodiment, argillaceous zone bases (SHB) are located by the following stages:

associating with each cell a vertical gradient value of distribution of the argillaceous zones (VGSH) from the second set of cells (SH); and
locating the argillaceous zone bases (SHB) from the vertical gradient values of distribution of the shales (VGSH).

According to this embodiment, a quality control of the location of the argillaceous zones base (SHB) can be performed by checking a coherence between connections between various cells containing CO₂ and discontinuities between the bases of the located argillaceous zones. The quality control of the location of the argillaceous zones base (SHB) can also be performed by γ ray logging in a well running through the geological layer. The method can also be repeated by modifying at least one of the thresholds when the quality control is negative.

Finally, the invention also relates to a method of monitoring a CO₂ geological storage site wherein argillaceous zones present in a geological layer, where the CO₂ is injected, are located, using the method according to the invention. It is also possible, within the context of a CO₂ geological storage site monitoring method of the invention, to locate hydraulic barriers in the entire geological layer covered by the seismic data where the CO₂ is injected, using the particular embodiment of the method according to the invention.

### BRIEF DESCRIPTION OF THE DRAWINGS

Other features and advantages of the method according to the invention will be clear from reading the description hereafter of embodiments given by way of non-limitative examples, with reference to the accompanying figures wherein:

FIG. 1 illustrates the stages of the method according to the invention;

FIG. 2 illustrates relationships between impedance Ip and ratio Ip/Is for various lithologies;

FIG. 3 illustrates three vertical sections of a binary shale distribution cube (SH) for three different criteria εₛₕ;

FIG. 4 illustrates three vertical sections of a binary cube (PLISH) of intersection between the CO₂ plume and the argillaceous lithology (FIG. 3) for three different criteria εₛₕ;

FIG. 5 illustrates a vertical section of cube VGSH showing the top and the base (left) and only the base (right) of the shales;

FIG. 6 illustrates a vertical section of final shale base cube FSHB at the level of a well, allowing comparison of the argillaceous lithologies deduced from the γ ray logs and the base of the shales deduced from the seismic survey;

FIG. 7A shows a vertical section of binary shale base distribution cube SHB calculated from the a priori model;

FIG. 7B shows a vertical section of binary CO₂ plume distribution cube PL; and

FIG. 7C shows a vertical section of binary shale base distribution cube FSHB calculated from the inverse model (obtained from the stratigraphic inversion).

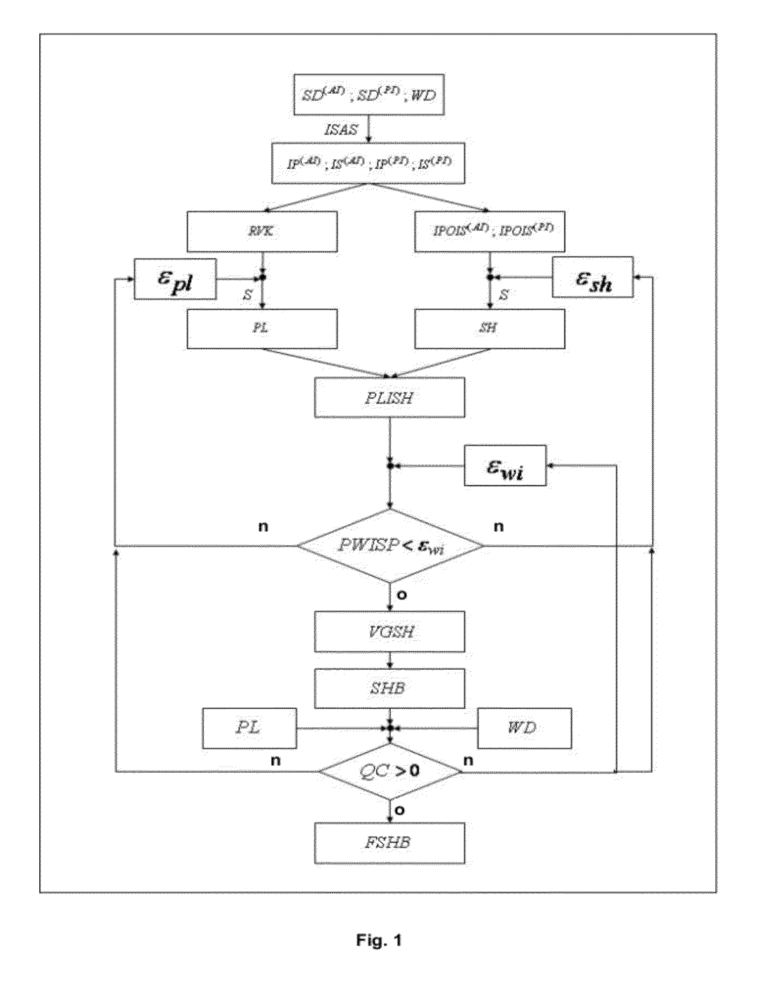

### DETAILED DESCRIPTION OF THE INVENTION

The method according to the invention allows location of argillaceous zones present in a geological layer into which a gas has been injected.

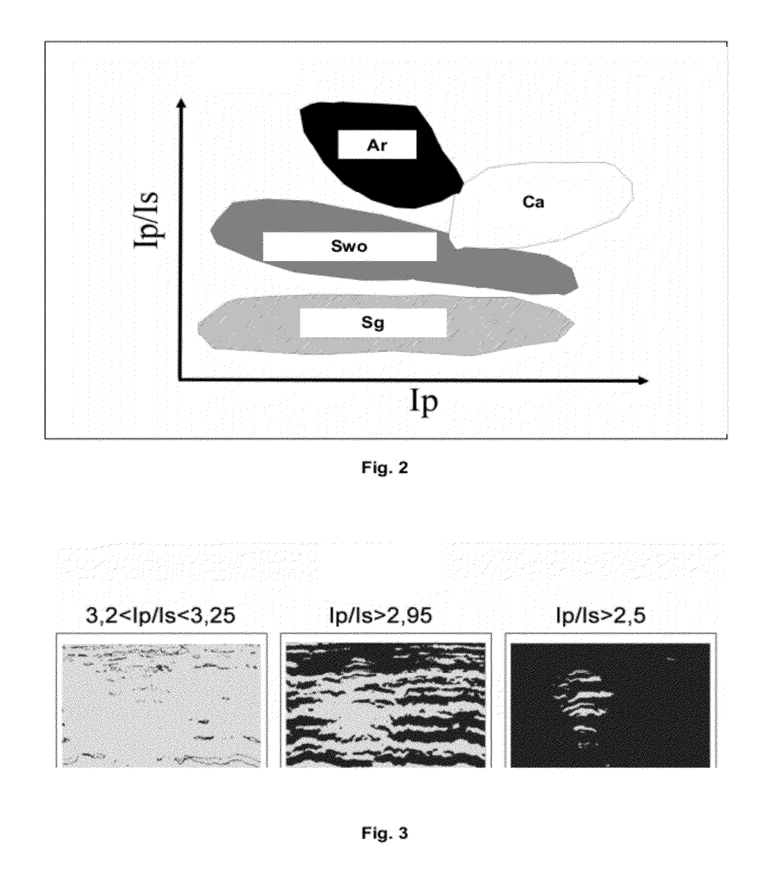

What is referred to herein as an argillaceous zone is a zone whose ratio of P wave seismic impedance (Ip) to S wave seismic impedance (Is) is greater than the ratio of these impedances in the gas storage layer. FIG. 2 illustrates the relationships between impedance Ip and ratio Ip/Is for different lithologies: Ar (shale), Ca (limestone), Swp (water/oil sands) and Sg (gas sands). FIG. 2 shows the selective character of the Ip/Is ratio towards the argillaceous and sandy lithologies.

From seismic data and a discretization of the layer into a set of cells (cube), the method comprises the following:

a) identifying a first set of cells (PL) containing CO₂ by analysing the seismic data by applying a first criterion;

b) identifying a second set of cells (SH) containing shale by analysing the seismic data by applying a second criterion;

c) determining a number of identified cells containing both CO₂ and shale, from the sets of cells (PL, SH); and

d) repeating a) by modifying at least one of the criteria, until the number of cells is below a selected threshold ε_{wi}.

The method is described within the context of CO₂ injection into a geological layer (aquifer) containing argillaceous zones, such as shale lenses. It comprises the following:

1. Data acquisition and CO₂ injection

2. CO₂ plume location

Determining the seismic impedances (or seismic wave velocities)

Constructing bulk modulus variation cubes

Locating the CO₂ plume

3. Argillaceous zones location

1. Data Acquisition and CO₂ Injection

A first set of 3D seismic data is first acquired prior to CO₂ injection (AI) into the aquifer. The first set allows imaging a subsoil zone containing the injection aquifer. This set is denoted by SD^{(AI)}. These data make up a first seismic amplitude cube.

CO₂ is injected into the aquifer.

A second set of 3D seismic data is then acquired (after CO₂ injection (PI)). This second set allows imaging the same subsoil zone as was imaged by the first data set. This set is denoted by SD^{(PI)}. These data make up a second seismic amplitude cube.

Thus, two images of a zone of the subsoil containing the injection aquifer are present. As it is known with 4D seismologists, the acquisition device for these seismic data must be substantially the same to obtain comparable images.

It is also possible to acquire, with a view to a stratigraphic inversion, well data denoted by WD. These data comprise density logs (well logs), as well as P and S wave velocity logs and γ ray logs.

2. CO₂ Plume Location

Locating the CO₂ plume in the subsoil is based on the knowledge of the relative variation of the bulk modulus of the geological formations of the subsoil invaded by the CO₂.

The bulk modulus, denoted by K, of a rock is the proportionality coefficient between the isotropic confinement pressure exerted on a sample of the rock and the relative volume variation (or volume deformation) of the sample resulting from the pressure.

Determination of these cubes of variation within the subsoil is based solely on the seismic impedances directly obtained from the seismic data. The following stages are generally carried outby associating with each cell P wave seismic impedance values before and after CO₂ injection and S wave seismic impedance values before and after CO₂ injection by a stratigraphic inversion of the seismic data;

associating with each cell a bulk modulus variation value from the P wave and S wave seismic impedance values before and after CO₂ injection; and determining the first set of cells (PL) containing CO₂ by identifying cells where the bulk modulus variation is negative with an absolute value above a given first positive threshold εₚₗ.

This method is described in detail hereafter.

2.1 Determining the Seismic Impedances (or Seismic Wave Velocities)

Determination of the seismic impedances is based on a stratigraphic inversion of the 4D seismic data cubes. Such a technique is well known.

According to an embodiment, the two seismic amplitude cubes are converted to seismic impedances (or seismic velocities) by a prestack stratigraphic inversion (ISAS).

Well data WD allow construction and calibration of an a priori model often used in stratigraphic inversion techniques.

The data obtained after inversion are the P wave and S wave impedance cubes, respectively denoted by IP^{(AI)} and IS^{(AI)} for the pre-injection data, and by IP^{(PI)} and IS^{(PI)} for the post-injection data.

All the data used are three-dimensional data cubes. The first two dimensions are horizontal geographical directions x and y, and the “vertical” third dimension is the seismic recording time t. These cubes thus represent a discretization of the subsoil into a set of cells. Each cell is associated with a value of a property as a function of the cube with the cells of the P wave impedance cube containing a P wave impedance value.

For the same depth, the recording time of a set of seismic data acquired at a given time is not the same as the recording time of a second set of seismic data acquired subsequently, because the velocities of propagation of the seismic waves in the rock are modified by the substitution of the CO₂ for the brine. These recording times are considered on different time scales.

Thus, the time scales are different for the pre- and post-injection impedance data.

As it is well known, the interpretation of 4D seismic data involves a stage of matching the propagation times of the two seismic data sets which are obtained before and after injection. Such a technique is commonly referred to as “warping” (W). An example is described in the following document:
DeVault B., et al., 2007, “Prestack 9-C Joint Inversion for Stratigraphic Prediction in the Williston Basin”. 77^{th} SEG Annual International Meeting, Expanded Abstracts, 1039-1043.

Thus, the post-injection impedance data IP^{(PI)} and IS^{(PI)} are temporally matched with the pre-injection data IP^{(AI)} and IS^{(AI)} to allow quantitative comparison thereof. The output data are the P wave and S wave post-warping impedance seismic data, respectively denoted by WIP^{(PI)} and WIS^{(PI)}, expressed in the same time reference frame as the pre-injection impedance data.

2.2 Constructing Bulk Modulus Variation Cubes

The impedance data are first converted to cubes of the product of bulk modulus K by density ρ of the subsoil. These cubes are denoted by KR^{(AI)} for the pre-injection cube and by KR^{(PI)} for the post-injection cube.

These conversions are performed using the following formulas:

$$\begin{matrix}( before injection ) & \\ {KR}^{( AI )} ( x , y , t ) = {( {IP}^{( AI )} ( x , y , t ) )}^{2} - \frac{4}{3} {( {IS}^{( AI )} ( x , y , t ) )}^{2} & ( 1 ) \\ ( after injection ) & \\ {KR}^{( PI )} ( x , y , t ) = {( {WIP}^{( PI )} ( x , y , t ) )}^{2} - \frac{4}{3} {( {WIS}^{( PI )} ( x , y , t ) )}^{2} . & ( 2 )\end{matrix}$$

These equations result from the fact that the velocities of the P waves, Vₚ, and of the S waves, Vₛ, and the associated impedances Iₚ and Iₛ respect the following equations:

$$ρ {V}_{P}^{2} = K + \frac{4}{3} μ ; ρ {V}_{S}^{2} = μ ; {I}_{P} = ρ {V}_{P}$$

$$and$$

$${I}_{S} = ρ {V}_{S}$$

The following formulas are deduced therefrom:

Kρ=I_{P}²−(4/3)I_{S}² and μρ=I_{S}²

The cubes of the relative variations of products K.ρ and μ.ρ, due to the injection of CO₂, are denoted by RVKR and RVMR respectively. They are deduced from the following formulas:

$$\begin{matrix}RVKR ( x , y , t ) = \frac{{KR}^{( PI )} ( x , y , t ) - {KR}^{( AI )} ( x , y , t )}{{KR}^{( AI )} ( x , y , t )} ; and & ( 5 ) \\ RVMR ( x , y , t ) = \frac{{MR}^{( PI )} ( x , y , t ) - {MR}^{( AI )} ( x , y , t )}{{MR}^{( AI )} ( x , y , t )} & ( 6 )\end{matrix}$$

By disregarding the pressure effects and the variations of the shear modulus μ due to the substitution of the CO₂ for the brine, the density relative variation cube, RVR, and the bulk modulus relative variation cube, RVK, are obtained by the following formulas:

RVR(x,y,t)=RVMR(x,y,t), and (7)

RVK(x,y,t)=RVKR(x,y,t)−RVMR(x,y,t) (8)

### 2.3 Locating the CO₂ Plume

The CO₂ has a lower bulk modulus and density than the brine. Substituting the CO₂ for the brine tends to decrease the density and the effective bulk modulus of the rock in the injection zone. The subsoil zones where density ρ decreases are located by calculating the filtered cube of the relative density variations, denoted by RVRF and defined by:

$$RVFR ( x , y , t ) = \{ \begin{matrix}1 if RVR ( x , y , t ) < 0 \\ 0 if RVR ( x , y , t ) > 0\end{matrix} \qquad ( 9 )$$

Similarly, the subsoil zones where bulk modulus K decreases are located by calculating the filtered cube of the relative bulk modulus variations, denoted by RVKF and defined by:

$$RVKF ( x , y , t ) = \{ \begin{matrix}1 if RVK ( x , y , t ) < 0 \\ 0 if RVK ( x , y , t ) > 0\end{matrix} \qquad ( 10 )$$

Furthermore, as a result of the many noise sources, essentially linked with the acquisition, this bulk modulus decrease is spatially coherent only above a certain bulk modulus relative variation threshold εₚₗ. The sufficient decrease zones for subsoil bulk modulus K are located by calculating the thresholded cube of the bulk modulus relative variations, denoted by PL and defined by:

$$PL ( x , y , t ) = \{ \begin{matrix}1 if \vert RVK ( x , y , t ) \vert > {ɛ}_{pl} \\ 0 if \vert RVK ( x , y , t ) \vert < {ɛ}_{pl}\end{matrix} \qquad ( 11 )$$

3. Argillaceous Zones Location

3.1 Initial Location of the Argillaceous Zones

Cubes IPOIS^{(AI)} and IPOIS^{(PI)} of the P wave and S wave impedance ratios, before and after injection, are calculated by means of the following formulas:

$$\begin{matrix}{IPOIS}^{( AI )} ( x , y , t ) = \frac{{IP}^{( AI )} ( x , y , t )}{{IS}^{( AI )} ( x , y , t )} ; and & ( 2 ) \\ {IPOIS}^{( PI )} ( x , y , t ) = \frac{{IP}^{( PI )} ( x , y , t )}{{IS}^{( PI )} ( x , y , t )} . & ( 3 )\end{matrix}$$

The argillaceous lithologies are known to have P wave impedance to S wave impedance ratios that are notably higher than the clastic (of sandstone type) or carbonate (of limestone or dolomite type) sedimentary rocks. Thus, above a certain threshold εₛₕ of the ratio of the P wave impedance to the S wave impedance, the lithology is assumed to be argillaceous. distribution binary cube SH is obtained by thresholding cube IPOIS^{(PI)} of the P wave impedance to S wave impedance ratio, after injection:

$$SH ( x , y , t ) = \{ \begin{matrix}1 if \vert {IPOIS}^{( PI )} ( x , y , t ) \vert > {ɛ}_{sh} \\ 1 if \vert {IPOIS}^{( PI )} ( x , y , t ) \vert > {ɛ}_{sh}\end{matrix} \qquad ( 4 )$$

It can be noted that another shale distribution binary cube SH by thresholding cube IPOIS^{(AI)} of the P wave impedance to S wave impedance ratio can be obtained before injection. However, the impedance contrasts between shales and sedimentary formations into which the gas is injected are intensified by the injection of CO₂. It is therefore often preferable to use cube IPOIS^{(PI)} of the P wave impedance to S wave impedance ratio, after injection. The same processing on cube IPOIS^{(AI)} before injection is often useful for controlling the coherence of the results.

FIG. 3 illustrates three vertical sections of a shale distribution binary cube (SH) for three different criteria εₛₕ, that is, from left to right, 3.2<Ip/Is <3.25, Ip/Is >2.95 and Ip/Is >2.5. The argillaceous lithologies are shown in black and the sandy lithologies in light grey. FIG. 3 is obtained in the case of CO₂ injection into a sandstone aquifer. The total vertical scale is about 350 m and the total horizontal scale is about 5.5 km.

3.2 Locating the Zones Identified as Containing Both Shale and CO₂

The binary cube PLISH of intersection between the CO₂ plume and the argillaceous lithology is obtained by multiplying the binary cube PL of CO₂ plume extension by the binary cube SH of shale distribution:

PLISH(x,y,t)=PL(x,y,t)×SH(x,y,t) (5)

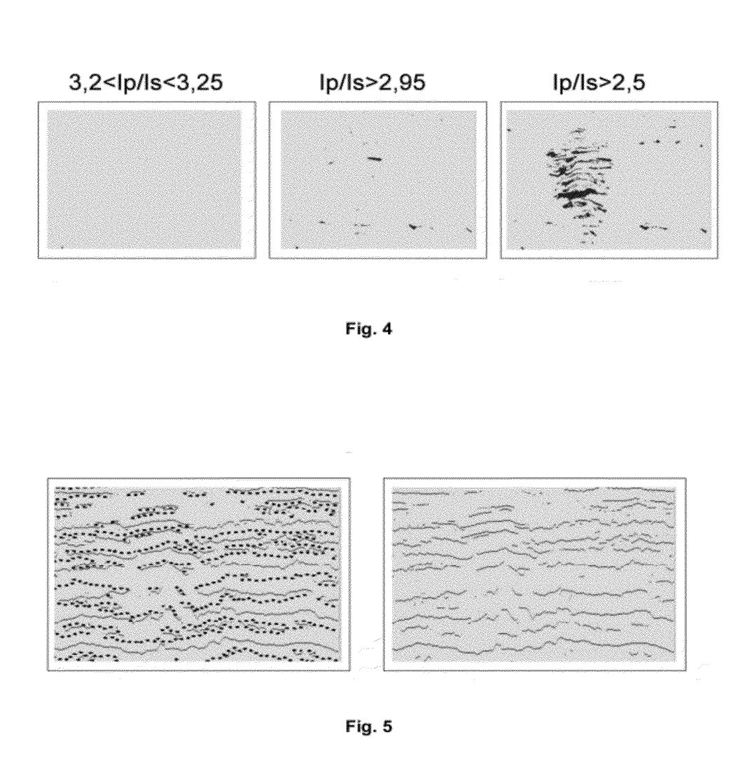

FIG. 4 illustrates three vertical sections of a binary cube (PLISH) of intersection between the CO₂ plume and the argillaceous lithology (FIG. 3), for three different criteria εₛₕ (used in FIG. 3). The black zones correspond to the intersection between the CO₂ plume and the argillaceous lithology. The total vertical scale is about 350 m and the total horizontal scale is about 5.5 km.

Since shales are much less permeable than clastic (of sandstone type) or carbonate (of limestone or dolomite type) sedimentary rocks, the CO₂ plume will therefore develop essentially in clastic or carbonate lithologies. Thus, in theory, the CO₂ plume should not intersect the argillaceous lithologies. In other words, binary cube (PLISH) of intersection between the CO₂ plume and the argillaceous lithology should comprise only value 0.

The number of 3D elementary pixels, known to specialists as voxels (contraction of “volumetric pixel”). The number NPL, which make up the entire CO₂ plume, is given by the formula:

$$NPL = {\sum }_{x , y , t}^{ } PL ( x , y , t ) \qquad ( 6 )$$

where symbol

$${\sum }_{x , y , t}^{ }$$

designates the sum of the values contained in the cube along dimensions x, y and t, or simply the sum of all the values of the elements of the cube being considered. Similarly, the number of voxels NWI in the geological injection layer, incorrectly identified as shale in the CO₂ plume, is:

$$NWI = {\sum }_{x , y , t}^{ } PLISH ( x , y , t ) \qquad ( 7 )$$

Thus, the proportion PWISP of voxels of the geological injection layer, incorrectly identified as shale in the CO₂ plume, is:

$$PWISP = \frac{NWI}{NPL} = \frac{{\sum }_{x , y , t}^{ } PLISH ( x , y , t )}{{\sum }_{x , y , t}^{ } PL ( x , y , t )} \qquad ( 8 )$$

3.3 Modifying the Location of Argillaceous Zones

PWISP is imposed below a certain tolerance threshold ε_{wi}. If PWISP is greater than ε_{wi}, threshold εₛₕ has to be updated for identification of the shales, and/or threshold εₚₗ has to be updated for estimation of the CO₂ plume extension. Then the procedure is resumed from stage 2 (location of the CO₂ plume).

### Other Embodiments

According to an embodiment, the hydraulic barriers present in the geological layer where gas has been injected are located from the location of the argillaceous zones.

What is referred to as a hydraulic (argillaceous) barrier is the lower boundary which is the deepest of the argillaceous zones. It is thus the base of the argillaceous zones. This base forms a boundary between the argillaceous zone and the porous layer into which the CO₂ is injected. It constitutes a barrier to the flow of fluids and it therefore prevents the CO₂ from flowing upward through gravity.

According to the invention, the argillaceous zone bases (SHB) are located by means of the following stages:

associating with each cell a vertical gradient value of distribution of the argillaceous zones (VGSH), from the second set of cells (cube SH); and
locating the argillaceous zone bases (SHB) from these vertical gradient values of distribution of the argillaceous zones (VGSH).

Thus, if PWISP is below ε_{wi}, cube VGSH of the vertical gradient of shale distribution is calculated from cube SH using the following formula:

VGSH(x,y,t)=SH(x,y,t+1)−SH(x,y,t) (9)

where elements SH(x, y,t+1) and SH(x,y,t) designate two successive elements on time axis t of cube SH. Cube VGSH can only contain the values 0, −1 or +1. Value 0 corresponds to the fact that SH(x,y,t+1) and SH(x,y,t) correspond to the same lithology, shale or non-shale. Value −1 corresponds to the shift from top to bottom from an argillaceous lithology to a non-argillaceous lithology, and value +1 to the inverse.

FIG. 5 illustrates a vertical section of Cube VGSH showing the top and the base (left) and only the base (right) of the shales, in the case of CO₂ injection into a sandstone aquifer. The total vertical scale is about 350 m and the total horizontal scale is about 5.5 km. The dotted lines show the shale top and the full lines the shale base.

Finally, shale base distribution binary cube SHB is calculated from cube VGSH using the following formula:

$$SHB ( x , y , t ) = \{ \begin{matrix}1 if VGSH ( x , y , t ) = - 1 \\ 0 if VGSH ( x , y , t ) \neq - 1\end{matrix} \qquad ( 10 )$$

According to another embodiment, a location quality control of the argillaceous zones base (SHB) is carried out.

Quality control of the shale base reproduction can be done in two manners. On the one hand, comparison of shale base distribution binary cube SHB and of CO₂ plume extension binary cube PL allows checking whether the connections between the various layers making up the CO₂ plume actually correspond to discontinuities on the shale base which are the only possible passage for the CO₂ through gravity from the bottom to the top of the reservoir. On the other hand, comparison of shale base distribution binary cube SHB and of the location in depth in the wells of the argillaceous lithologies deduced from the γ ray logs allows checking the coherence of the number and of the depths of the shale bases deduced from the logs and the seismic data.

From these comparisons, estimating whether there is a sufficient match between shale base distribution binary cube SHB and the CO₂ plume extension and the argillaceous lithology levels deduced from the γ ray logs is a matter for geological/seismic interpreters.

If the match is insufficient, that is in case of a negative quality control (i.e. QC<0), tolerance threshold ε_{wi} has to be updated for the wrong identification of the argillaceous lithology in the CO₂ plume and then the procedure is resumed. If the shale base reproduction quality is still insufficient, it is also possible to update again threshold εₛₕ for identification of the shales and the threshold εₚₗ for estimation of the CO₂ plume extension and then the procedure is resumed.

If the match is sufficient, that is in case of a positive quality control (that is QC>0), the shale base distribution binary cube is considered to be the final shale base distribution cube FSHB.

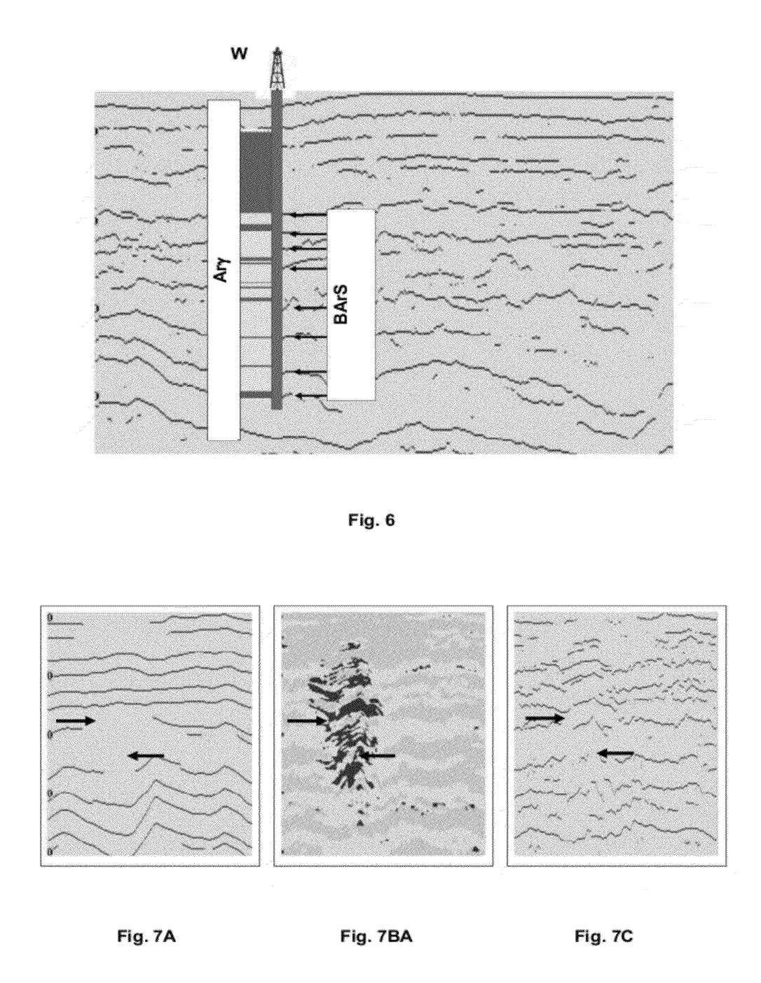

FIG. 6 illustrates a vertical section of final cube FSHB of the shale base in a well (W) allowing comparison of the argillaceous lithologies (Arγ) deduced from the γ ray logs and the shale base (ArS) deduced from the seismic data. FIG. 6 is obtained in the case of CO₂ injection into a sandstone aquifer. The total vertical scale is about 350 m and the total horizontal scale is about 5.7 km.

FIGS. 7A, 7B and 7C illustrate the capacity of the method according to the invention to precisely locate the possible connections between the various reservoir compartments which are not only at the level of the CO₂ plume but also in the entire geological layer which is far away from the injection zone. FIG. 7A shows a vertical section of shale base distribution binary cube SHB calculated from the a priori model. FIG. 7B shows a vertical section of CO₂ plume extension binary cube PL. FIG. 7C shows a vertical section of shale base distribution binary cube FSHB calculated from the inverse model (resulting from the stratigraphic inversion). In each figure, an arrow shows a connection between various layers that make up the CO₂ plume.

It should be noted that the two connections do not pre-exist in the a priori model (FIG. 7A) but they are highlighted by the stratigraphic inversion of the seismic data (FIG. 7C).

The invention also relates to a method of monitoring a CO₂ geological storage site wherein argillaceous zones present in the geological layer covered by the seismic data into which CO₂ has been injected are located, using the method according to the invention.

It is also possible, within the context of a CO₂ geological storage site monitoring method, to locate hydraulic barriers in the entire geological layer covered by the seismic data and into which the CO₂ is injected by using the particular embodiment of the method according to the invention.

Precise detection of the argillaceous zones and of the hydraulic barriers thus allows optimizing the development of the storage site by optimizing the injection or the site monitoring.

1-10. (canceled)

11. A method of locating argillaceous zones present in a geological layer, where CO₂ has been injected, from seismic data and from a discretization of the layer into a set of cells, comprising:
a) identifying a first set of cells containing CO₂ by an analysis of the seismic data with a first criterion;
b) identifying a second set of cells containing shale by an analysis of the seismic data with a second criterion;
c) determining a number of identified cells containing both CO₂ and shale, from the sets of cells; and
d) repeating a) by modifying at least one of the criterion, until the number of cells is below a selected threshold.

12. A method as claimed in claim 11 wherein the first set of cells containing CO₂ is determined by:
associating with each cell P wave seismic impedance values before and after CO₂ injection and S wave seismic impedance values before and after CO₂ injection by a stratigraphic inversion of the seismic data;
associating with each cell a bulk modulus variation value from the P wave and S wave seismic impedance values before and after CO₂ injection; and
determining the first set of cells containing CO₂ by identifying cells where the bulk modulus variation is negative with an absolute value above a given first positive threshold.

13. A method as claimed in claim 11 wherein the second set of cells containing shale is determined by:
associating with each cell a P wave seismic impedance value before or after CO₂ injection and an S wave seismic impedance value before or after CO₂ injection by a stratigraphic inversion of the seismic data,
associating with each cell a value of a ratio of the P wave seismic impedance to the S wave seismic impedance; and
determining the second set of cells containing shale by identifying cells where the ratio is above a given second positive threshold.

14. A method as claimed in claim 12 wherein the second set of cells containing shale is determined by:
associating with each cell a P wave seismic impedance value before or after CO₂ injection and an S wave seismic impedance value before or after CO₂ injection by a stratigraphic inversion of the seismic data,
associating with each cell a value of a ratio of the P wave seismic impedance to the S wave seismic impedance; and
determining the second set of cells containing shale by identifying cells where the ratio is above a given second positive threshold.

15. A method as claimed in claim 12 wherein at least one of the thresholds is modified upon each iteration of d).

16. A method as claimed in claim 13 wherein at least one of the thresholds is modified upon each iteration of d).

17. A method as claimed in claim 14 wherein at least one of the thresholds is modified upon each iteration of d).

18. A method as claimed in claim 11 wherein argillaceous zone bases are located by:
associating with each cell a vertical gradient value of a distribution of the argillaceous zone from the second set of cells; and
locating argillaceous zone bases from the vertical gradient values of distribution of the shales.

19. A method as claimed in claim 12 wherein argillaceous zone bases are located by:
associating with each cell a vertical gradient value of a distribution of the argillaceous zone from the second set of cells; and
locating argillaceous zone bases from the vertical gradient values of distribution of the shales.

20. A method as claimed in claim 13 wherein argillaceous zone bases are located by:
associating with each cell a vertical gradient value of a distribution of the argillaceous zone from the second set of cells; and
locating argillaceous zone bases from the vertical gradient values of distribution of the shales.

21. A method as claimed in claim 14 wherein argillaceous zone bases are located by:
associating with each cell a vertical gradient value of a distribution of the argillaceous zone from the second set of cells; and
locating argillaceous zone bases from the vertical gradient values of distribution of the shales.

22. A method as claimed in claim 15 wherein argillaceous zone bases are located by:
associating with each cell a vertical gradient value of a distribution of the argillaceous zone from the second set of cells; and
locating argillaceous zone bases from the vertical gradient values of distribution of the shales.

23. A method as claimed in claim 16 wherein argillaceous zone bases are located by:
associating with each cell a vertical gradient value of a distribution of the argillaceous zone from the second set of cells; and
locating argillaceous zone bases from the vertical gradient values of distribution of the shales.

24. A method as claimed in claim 17 wherein argillaceous zone bases are located by:
associating with each cell a vertical gradient value of a distribution of the argillaceous zone from the second set of cells; and
locating argillaceous zone bases from the vertical gradient values of distribution of the shales.

25. A method as claimed in claim 18 wherein a quality control of a location of the argillaceous zones base is performed by checking a coherence between connections between cells containing CO₂ and discontinuities between the located bases of the argillaceous zones.

26. A method as claimed in claim 19 wherein a quality control of a location of the argillaceous zones base is performed by checking a coherence between connections between cells containing CO₂ and discontinuities between the located bases of the argillaceous zones.

27. A method as claimed in claim 20 wherein a quality control of a location of the argillaceous zones base is performed by checking a coherence between connections between cells containing CO₂ and discontinuities between the located bases of the argillaceous zones.

28. A method as claimed in claim 21 wherein a quality control of a location of the argillaceous zones base is performed by checking a coherence between connections between cells containing CO₂ and discontinuities between the located bases of the argillaceous zones.

29. A method as claimed in claim 22 wherein a quality control of a location of the argillaceous zones base is performed by checking a coherence between connections between cells containing CO₂ and discontinuities between the located bases of the argillaceous zones.

30. A method as claimed in claim 23 wherein a quality control of a location of the argillaceous zones base is performed by checking a coherence between connections between cells containing CO₂ and discontinuities between the located bases of the argillaceous zones.

31. A method as claimed in claim 24 wherein a quality control of a location of the argillaceous zones base is performed by checking a coherence between connections between cells containing CO₂ and discontinuities between the located bases of the argillaceous zones.

32. A method as claimed in claim 18 wherein a quality control of a location of the base of the argillaceous zone is performed by γ ray logging in a well running through the geological layer.

33. A method as claimed in claim 19 wherein a quality control of a location of the base of the argillaceous zone is performed by γ ray logging in a well running through the geological layer.

34. A method as claimed in claim 20 wherein a quality control of a location of the base of the argillaceous zone is performed by γ ray logging in a well running through the geological layer.

35. A method as claimed in claim 21 wherein a quality control of a location of the base of the argillaceous zone is performed by γ ray logging in a well running through the geological layer.

36. A method as claimed in claim 22 wherein a quality control of a location of the base of the argillaceous zone is performed by γ ray logging in a well running through the geological layer.

37. A method as claimed in claim 23 wherein a quality control of a location of the base of the argillaceous zone is performed by γ ray logging in a well running through the geological layer.

38. A method as claimed in claim 24 wherein a quality control of a location of the base of the argillaceous zone is performed by γ ray logging in a well running through the geological layer.

39. A method as claimed in claim 25 comprising modifying at least one of the thresholds when the quality control is negative.

40. A method as claimed in claim 32 comprising modifying at least one of the thresholds when the quality control is negative.

41. A method as claimed in claim 11 comprising monitoring a CO₂ geological storage site wherein argillaceous zones present in a geological layer into which CO₂ is injected are located.

42. A method as claimed in claim 12 comprising monitoring a CO₂ geological storage site wherein argillaceous zones present in a geological layer into which CO₂ is injected are located.

43. A method as claimed in claim 13 comprising monitoring a CO₂ geological storage site wherein argillaceous zones present in a geological layer into which CO₂ is injected are located.

44. A method as claimed in claim 15 comprising monitoring a CO₂ geological storage site wherein argillaceous zones present in a geological layer into which CO₂ is injected are located.

45. A method as claimed in claim 18 comprising monitoring a CO₂ geological storage site wherein argillaceous zones present in a geological layer into which CO₂ is injected are located.

46. A method as claimed in claim 25 comprising monitoring a CO₂ geological storage site wherein argillaceous zones present in a geological layer into which CO₂ is injected are located.

47. A method as claimed in claim 32 comprising monitoring a CO₂ geological storage site wherein argillaceous zones present in a geological layer into which CO₂ is injected are located.

48. A method as claimed in claim 18 comprising monitoring a CO₂ geological storage site wherein hydraulic barriers are located in an entire geological layer covered by the seismic data into which CO₂ is injected

49. A method as claimed in claim 25 comprising monitoring a CO₂ geological storage site wherein hydraulic barriers are located in an entire geological layer covered by the seismic data into which CO₂ is injected

50. A method as claimed in claim 32 comprising monitoring a CO₂ geological storage site wherein hydraulic barriers are located in an entire geological layer covered by the seismic data into which CO₂ is injected

51. A method as claimed in claim 39 comprising monitoring a CO₂ geological storage site wherein hydraulic barriers are located in an entire geological layer covered by the seismic data into which CO₂ is injected
